(19) United States
(12) Patent Application Publication
(10) Pub. No.: US 2015/0288806 A1
(43) Pub. Date: Oct. 8, 2015

(54) Handsfree Phone Device

(71) Applicant: Hosiden Corporation, Yao-shi (JP)

(72) Inventors: Shunji Muraoka, Yao-shi (JP); Kiyoshi Miyazawa, Yao-shi (JP); Yoshifumi Yamanaka, Yao-shi (JP)

(21) Appl. No.: 14/670,784

(22) Filed: Mar. 27, 2015

(30) Foreign Application Priority Data
Apr. 2, 2014 (JP) 2014-076081
May 26, 2014 (JP) 2014-108147

(51) Int. Cl. H04M 3/00; H04M 1/60

(52) U.S. Cl. CPC H04M 3/002; H04M 1/6075

(57) ABSTRACT

Provided is a handsfree phone device that does not impair the phone communication quality and that can be realized at low costs. The device includes a relay module configured to relay communication between a phone terminal and an informing terminal, a first signal line and a second signal line interconnecting the relay module and the informing terminal, a wired relay section included in the relay module and configured to transmit a received call signal transmitted from the phone terminal to the relay module to the informing terminal via the first signal line, a voice signal transmitting section included in the informing terminal and configured to transmit a voice signal based on the received call signal to the relay module via one of the first signal line and the second signal line, and an echo canceling section included in the relay module and configured to reduce an echo generated when the received call signal outputted from the speaker is inputted to a microphone included in the relay module, with use of the voice signal.

### CROSS REFERENCE TO RELATED APPLICATIONS

This application claims priority to Japanese Patent Application No. 2014-076081 and 2014-108147 filed Apr. 2, 2014 and May 26, 2014, respectively, the disclosures of which are hereby incorporated in their entirety by reference.

### TECHNICAL FIELD

This disclosure relates to a handsfree phone device configured to output a voice call (communication) by a user using a phone terminal from a speaker included in an informing terminal.

### RELATED ART

In recent years, in a situation where phone terminals such as mobile phones are widely used, handsfree phone devices have also been employed in view of the concern that if a driver engaged in driving of a vehicle for instance makes a call with holding a phone terminal by hand, this may interfere with the driving operation. As a technique of this type, there is one disclosed in e.g. JP2013-168845A.

A car-mounted handsfree device disclosed in JP2013-168845A includes a speaker and a microphone. When the mobile phone (phone terminal) receives an incoming call, and a handsfree phone communication is started, the received voice received by the mobile phone is forwarded to a communication interface section of the car-mounted handsfree device and then outputted from the speaker of this car-mounted handsfree device. On the other hand, a speech voice inputted via the microphone is forwarded to the mobile phone via the communication interface section of the car-mounted handsfree device to be transmitted subsequently to the terminal device of the other party.

### SUMMARY

With the technique disclosed in JP2013-168845A, a handsfree phone communication by a phone terminal is made possible. With this technique; however, when the phone terminal receives a call and the speech voice is outputted from the speaker included in the car-mounted handsfree device, a howling phenomenon can sometimes occur when this speech voice is inputted to the microphone of the phone terminal. As a result, the phone communication quality of the phone terminal is impaired. Then, it is conceivable to omit such output of speech voice from the speaker of the car-mounted, but to transmit firstly the speech voice from the phone terminal to the communication interface of the car-mounted handsfree device and then to transmit it from this communication interface section to the phone terminal. However, in order to transmit a speech voice from the speaker of the car-mounted handsfree device to the communication interface section, a special cable is needed, thus being a cause for cost increase.

Embodiments of the present invention comprise a handsfree phone device that does not impair the phone communication quality and that can be realized at low costs.

According to one embodiment of a handsfree phone device relating to this disclosure, a handsfree phone device configured to output a call by a user using a phone terminal from a speaker included in an informing terminal, the handsfree phone device comprises:
a relay module configured to communicate with the phone terminal and also to effect wired communication with the informing terminal, thus relaying communication between the phone terminal and the informing terminal;
a first signal line and a second signal line interconnecting the relay module and the informing terminal;
wherein the handsfree phone device further comprises:
a wired relay section included in the relay module and configured to transmit a received call signal transmitted from the phone terminal to the relay module to the informing terminal via the first signal line;
a voice signal transmitting section included in the informing terminal and configured to transmit a voice signal based on the received call signal to the relay module via one of the first signal line and the second signal line; and
an echo canceling section included in the relay module and configured to reduce an echo generated when the received call signal outputted from the speaker is inputted to a microphone included in the relay module, with use of the voice signal.
With the above-described configuration, a voice signal based on a received call signal transmitted from the relay module to the informing terminal via the first signal line can be transmitted from the informing terminal to the relay module via one of the first signal line and the second signal line which are used originally for communication between the relay module and the informing terminal. Therefore, for transmission of a voice signal from the informing terminal to the relay module, there is no need to provide any additional signal line, so that no cost increase will occur. Further, since the echo cancelling section reduces generation of echo with use of the voice signal transmitted from the informing terminal, deterioration in the phone communication quality in the phone terminal can be prevented also.

Further, according to one embodiment of the handsfree phone device, the first signal line and the second signal line respectively comprise a differential signal line and an ID signal line of a universal serial bus; and the voice signal transmitting section is configured to transmit the voice signal to the relay module, with superposing this voice signal on an ID signal transmitted by the ID signal line.

With the above-described configuration, the received call signal can be transmitted by way of a differential signal from the relay module to the informing terminal. Further, from the informing terminal to the relay module, the voice signal based on the received call signal can be transmitted as being superposed on an ID signal which is a DC signal. Therefore, as the configuration can utilize cables of an existing universal serial bus, the configuration can be realized at low costs.

Alternatively, according to a further embodiment of the handsfree phone device, the first signal line and the second signal line respectively comprise a differential signal line and an ID signal line of a universal serial bus; and the voice signal transmitting section is configured to transmit the voice signal to the relay module, by way of a differential signal via the differential signal line.

In the case of the above-described configuration, from the relay module to the informing terminal, the received call signal can be transmitted by way of a differential signal. Further, from the informing terminal to the relay module, the voice signal based on the received call signal can also be transmitted by way of a differential signal. Therefore, as the configuration can utilize a cable of an existing universal serial bus, the configuration can be realized at low costs. Moreover, since the differential signal is a digital signal, the transmission is made possible with effective prevention of distortion or quality deterioration of an analog signal such as a voice signal in the informing terminal. Therefore, by effecting a high-quality digital signal processing in the informing terminal, signal distortion or deterioration can be avoided, so that generation of echo can be eliminated entirely.

Further, according to a still further embodiment of the handsfree phone device, the voice signal transmitting section is configured to transmit a voice signal other than the received call signal outputted from the speaker to the relay module via one of the first signal line and the second signal line for transmitting the voice signal based on the received call signal.

In the case of the above-described configuration, it is made possible to reduce generation of an echo due to various kinds of sound outputted from the speaker included in the informing terminal such as sounds from a TV set, a radio, etc. Therefore, it is possible to prevent deterioration of phone communication quality in the phone terminal.

Further, according to a still further embodiment of the handsfree phone device, the voice signal transmitting section is configured to transmit the voice signal with frequency modulation thereof.

In the case of the above-described configuration, since the voice signal is subjected to frequency modulation, influence of disturbance noise can be reduced even in the case of a weak voice signal. Therefore, since the voice signal outputted from the speaker of the informing terminal can be completely echo-cancelled by the relay module, it is made possible to transmit the voice from the microphone of the relay module to the other party without impairment of its quality.

### BRIEF DESCRIPTION OF THE DRAWINGS

FIG. 1 is a block diagram schematically showing a configuration of a handsfree phone device,

FIG. 2 is a flowchart illustrating a processing effected by the handsfree phone device according to a first embodiment, and

FIG. 3 is a flowchart illustrating a processing effected by a handsfree phone device according to a second embodiment.

### DESCRIPTION OF EMBODIMENTS

### 1. First Embodiment

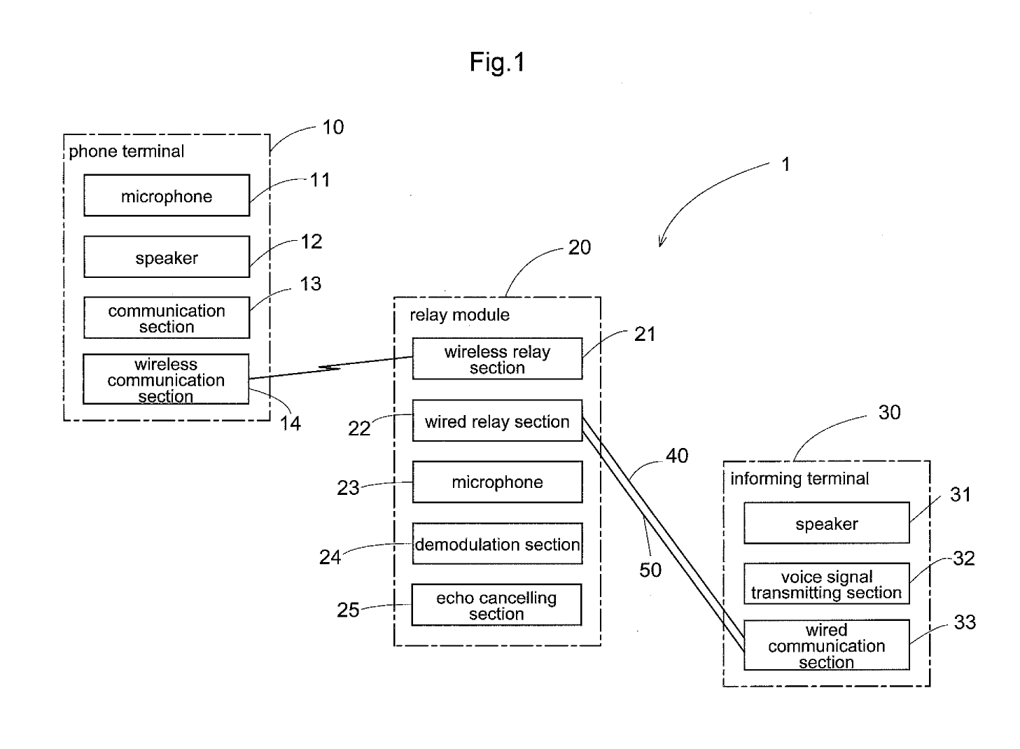

A handsfree phone device relating to this disclosure has a function of outputting a phone communication by a user via a phone terminal from a speaker included in an informing terminal. Next, a handsfree phone device 1 relating to a first embodiment will be explained. FIG. 1 shows a block diagram schematically showing a configuration of the handsfree phone device 1 relating to the first embodiment. As shown in FIG. 1, the handsfree phone device 1 includes a relay module 20, a first signal line 40, a second signal line 50, and a voice signal transmitting section 32.

The relay module 20 relays phone communication between a phone terminal 10 and an informing terminal 30. The phone terminal 10 refers to a terminal capable of phone communication. More particularly, this corresponds to a mobile phone, a smart phone, etc. The phone terminal 10, as shown in FIG. 1, includes a microphone 11, a speaker 12, a communication section 13, and a wireless communication section 14.

The microphone 11 collects a voice relating to a phone communication carried out via the phone terminal 10 and converts this voice into a voice signal. The speaker 12 converts the voice signal (corresponding to “a received call signal” in the context of this disclosure) received by the phone terminal 10 from another phone terminal into a voice and outputs this voice. The communication section 13 effects reception and transmission of the voice signal handled by the microphone 11 and the speaker 12 from/to another communication terminal. The wireless communication section 14 effects wireless communication with the relay module 20.

The relay module 20 is configured to effect such communication with the phone terminal 10. Incidentally, the communication between the relay module 20 and the phone terminal 10 can be either wireless communication or wired communication. Here, the term “wireless communication” refers to a mode of communication of aerial propagation of a signal received/transmitted therebetween. Whereas, the term “wired communication” refers to a mode of communication by propagation using a signal line. In the instant embodiment, there will be explained with reference to an example in which the phone terminal 10 and the relay module 20 carry out wireless communication. In the case of wired communication, a wired communication section can be provided instead of the wireless communication section 14. Further, in this case, it will be advantageous that a wireless relay section 21 to be described later in the relay module 20 will be replaced by a wired communication section.

The informing terminal 30 is provided separately from the phone terminal 10 and informs that the phone terminal 10 is engaged in call reception. This informing of call reception can be informing by way of a voice or visual informing. In the instant embodiment, the informing terminal 30 corresponds to a car navigation system mounted on a vehicle.

The relay module 20 is connected to the informing terminal 30 via a first signal line 40 and a second signal line 50 and effects wired communication therewith. In the instant embodiment, the relay module 20 and the informing terminal 30 are connected with using a cable of a universal serial bus including a connector having five pins at opposed ends of a cable. The “five pins” mentioned above comprise a pair of differential signal pins, a power supply pin, a GND pin and an ID signal pin. The communication between the relay module 20 and the informing terminal 30 uses a pair of differential signal lines (corresponding to “a first signal line 40” in the context of this disclosure) connected to the pair of differential signal pins and an ID signal line (corresponding to “a second signal line 50” in the context of the present disclosure) connected to the ID signal pins.

The first signal line 40 transmits a first data signal transmitted/received between the relay module 20 and the informing terminal 30. As described above, the first signal line 40 corresponds to the differential signal lines of the cable included in the universal serial bus. Therefore, between the relay module 20 and the informing terminal 30, data are transmitted/received by way of differential signals via the first signal line 40; and the first data signal corresponds to differential signals. The first data signal includes the received call signal transmitted from the phone terminal 10 to the relay terminal 20. Here, the language “received call signal” refers to electric signals converted based on a phone call transmitted from another phone terminal as the call destination of the phone terminal 10.

The second signal line 50 transmits a second data signal transmitted/received between the relay module 20 and the informing terminal 30, the second data signal being different from the first data signal. As described above, the second signal line 50 corresponds to the ID signal line of the cable included in the universal serial bus. Therefore, between the relay module 20 and the informing terminal 30, ID signal is transmitted/received via the second signal line 50 and the second signal data corresponds to DC signals.

The informing terminal 30, as shown in FIG. 1, includes a speaker 31, a voice signal transmitting section 32 and a wired communication section 33. The speaker 31 outputs navigation information by the navigation system as a voice to the inside of the vehicle cabinet. In case the state of the phone terminal 10 being engaged in incoming call reception by way of a voice, this speaker 31 outputs this voice. The wired communication section 33 corresponds to an I/O (input/output) interface which is connected to the relay module 20 via the first signal line 40 and the second signal line 50 for transmitting/receiving communication data exchanged with the relay module 20.

The voice signal transmitting section 32 adds a voice signal based on a voice signal transmitted via the first signal line 40 and transmits the resultant signal to the relay module 20 via the second signal line 50. In the above, the language “received call signal” transmitted via the first signal line 40 refers to the received call signal included in the first data signal transmitted from the phone terminal 10 to the relay module 20 and then from this relay module 20 to the informing terminal 30. The informing terminal 30 outputs this received call signal via the speaker 31. Simultaneously, the informing terminal 30 superposes the voice signal converted by a predetermined processing from the speaker driving signal on the second data signal. Here, the language “voice signal” refers to a waveform which is oscillated in accordance with the kind, magnitude, high/low pitch of the voice, and the second data signal comprises a DC signal. The voice signal transmitting section 32 superposes the voice signal on the second data signal (ID signal) transmitted via the second signal line 50 (ID signal line) and then transmits the resultant signal to the relay module 20. More particularly, the voice signal transmitting section 32 generates a signal mixing a DC signal and a voice signal (“a mixed signal” hereinafter) and then transmits this mixed signal to the relay module 20 via the second signal line 50.

In the instant embodiment, the voice signal transmitting section 32 effects frequency modulation of the voice signal and adds this to the second data signal and transmits the resultant signal. With this arrangement, even when the level of the voice signal is low, it is made possible to enhance noise resistance against disturbance noise. It is also made possible to restrict delay in transmission. The mixed signal generated by the voice signal transmitting section 32 is transmitted via the wired communication section 33 to the relay module 20. Incidentally, although the ID signal is a DC signal, as detection is effected in the DC level according to the established standard of universal serial bus, no adverse effect will be imposed on the detection of ID signal even when such frequency-modulated voice signal is superposed on the ID signal. However, if such influence should be imposed, it will be advantageous to make connection to the ID detection circuit via a low-pass filter for eliminating frequency-modulated signal.

The relay module 20 includes a wireless relay section 21, a wired relay section 22, a microphone 23, a demodulation section 24, and an echo cancelling section 25. The wireless relay section 21 is connected wirelessly to the wireless communication section 14 of the phone terminal 10 and effects transmission/reception of data with the relay module 20 of the phone terminal 10. The wired relay section 22 is connected in a wired manner to the wired communication section 33 of the informing terminal 30 via the first signal line 40 and effects data transmission/reception with the relay module 20 of the informing terminal 30. Therefore, the received call signal transmitted from the phone terminal 10 to the relay module 20 is transmitted by the wired relay section 22 via the first signal line 40 to the informing terminal 30. The microphone 23 collects a user's speech voice when this user is unable to talk with holding the phone terminal 10 by hand and converts it into an electric signal. Then, this electric signal is transmitted via the wireless relay section 21 to the phone terminal 10 and transmitted from its communication section 13 to the other party's phone terminal.

The demodulation section 24 demodulates the mixed signal transmitted from the informing terminal 30 into a voice signal. Namely, the demodulation section 24 extracts the voice signal superposed on the ID signal from the mixed signal. This voice signal is utilized in the relay module 20 for echo cancelling on the transmission side. As this echo cancelling is to be effected by the echo cancelling section 25, the voice signal extracted by the demodulation section 24 is transmitted to the echo cancelling section 25.

In the echo cancelling section 25, an echo generated when the received call signal outputted from the speaker 31 included in the informing terminal 30 is inputted to the microphone 23 included in the relay terminal 20 is reduced with use of the voice signal. Here, the received call signal outputted from the speaker 31 included in the informing terminal 30 refers to the received call signal transmitted from the relay module 20 via the first signal line 40. The “voice signal” refers to the voice signal demodulated by the demodulation section 24.

Further, in this embodiment, the echo cancelling section 25 receives also a sound other than the received call signal which sound is also outputted from the speaker 31 and added to the second data signal and then transmitted from the voice signal transmission section 32 via the second signal line 50 for transmitting a voice signal based on a received call signal. Here, the language “a sound other than the received call signal” refers to a sound relating to a TV or radio broadcasting outputted from the speaker 31 of the informing terminal 30 or a sound inputted to the informing terminal 30 via variety of media such as a DVD. With utilizing such voice signal, the echo cancelling section 25 cancels out a sound outputted from the speaker 31 of the informing terminal 30 and inputted to the microphone 23. As a result, although the sound inputted to the microphone 23 contains a sound outputted from the speaker 31 of the informing terminal 30 and a speech sound of the calling party in a mixed state, it is made possible to transmit to the phone terminal 10 only the speech sound of the calling party with cancellation of the sound outputted from the speaker 31 with use of the voice signal.

With the above-described configuration of the handsfree phone device 1, it is made possible to inform from the informing terminal 30 only the reception of incoming call by the phone terminal 10 and also to maintain good phone communication quality during phone call.

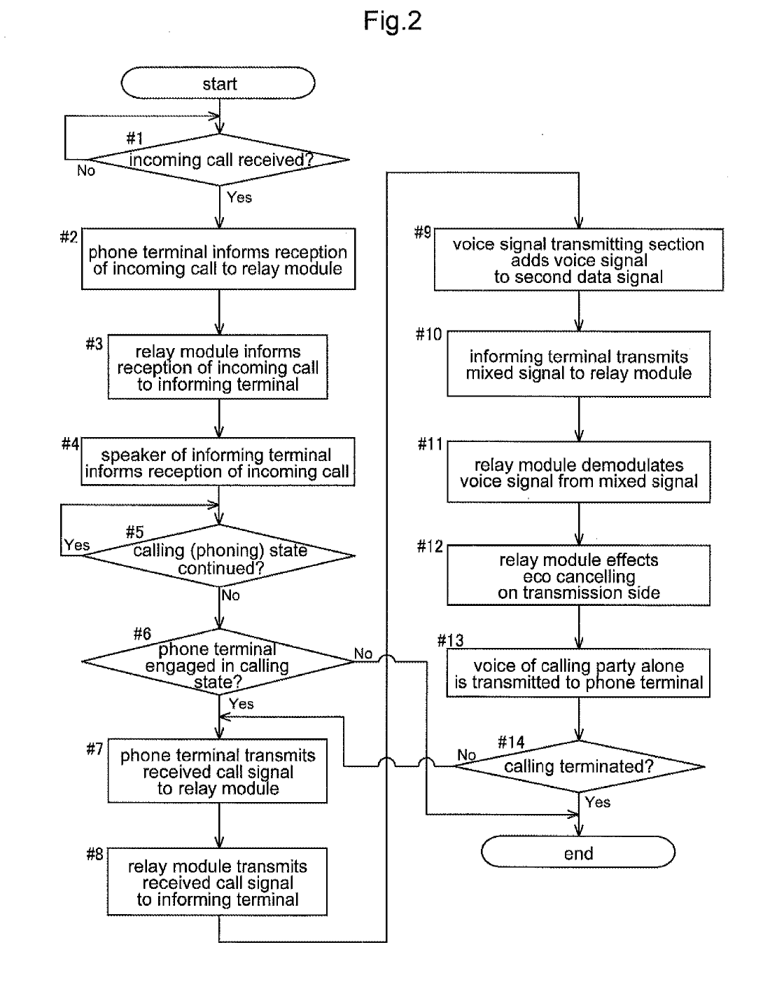

Next, with reference to the flowchart shown in FIG. 2, there will be explained a processing effected by the handsfree phone device 1 relating to the first embodiment. In the following discussion, there will be explained an example wherein the phone terminal 10 and the relay module 20 effect wireless communication whereas the relay module 20 and the informing terminal 30 effect wired communication, and also reception of an incoming call by the phone terminal 10 is informed via the relay module 20 to the informing terminal 30 and this is then informed (alerted) by way of a voice via the speaker 31 of the informing terminal 30.

When the phone terminal 10 receives a phone call (step #1: Yes), the phone terminal 10 informs this reception of a phone call to the relay module 20 (step #2). This informing is carried out between the wireless communication section 14 of the phone terminal 10 and the wireless relay section 21 of the relay module 20.

Upon reception of the informing from the phone terminal 10, the relay module 20 informs this reception to the informing terminal 30 (step #3). This informing is carried out by transmission of the differential signal on the first signal line 40 between the wired relay section 22 of the relay module 20 and the wired communication section 33 of the informing terminal 30. Then, the informing terminal 30 informs this reception from the speaker 31 of this informing terminal 30 (step #4). This informing will be continued until termination of the call reception state of the phone terminal 10 (step #5: Yes).

If the cause of the above termination of informing is entry of the phone terminal 10 to a calling (phoning) state (step #6: Yes), when the phone terminal 10 receives a received call signal from another phone terminal 10 of the other (i.e. calling) party, the phone terminal 10 will transmit the received call signal to the relay module 20 (step #7). Then, the relay module 20 transmits this received call signal to the informing terminal 30 via the first signal line 40 (step #8).

Upon receipt of the received call signal, the informing terminal 30 outputs a voice relating to the received call signal from the speaker 31. Simultaneously, the voice signal transmitting section 32 generates a voice signal based on speaker driving signal which is mixture of the received call signal and the signal of the informing terminal 30 (when a sound other than the received call signal is being outputted from the speaker 31) and then adds this voice signal to the second data signal which comprises a DC signal (step #9). In the following discussion, explanation will proceed with referring to the second data signal added with the voice signal as a mixed signal.

The mixed signal generated by the voice signal transmitting section 32 is transmitted to the relay module 20 via the second signal line 50 (step #10). When the relay module 20 receives the mixed signal from the informing terminal 30, the demodulation section 24 carries out demodulation by extracting the voice signal from the mixed signal (step #11). The voice signal demodulated by the demodulation section 24 then is utilized for echo cancelling on the transmission side in the relay module 20 (step #12).

The sound outputted from the speaker 31 of the informing terminal 30 is subjected to cancelling operation by the echo cancelling section 25 and the calling party's voice alone is transmitted to the phone terminal 10 (step #13). This processing will be continued until the phone terminal 10 terminates the phone communication (step #14: No). If it is determined at step #6 that the cause of the above termination of informing is not entry of the phone terminal 10 to a calling (phoning) state (step #6: No) or if the phone terminal 10 terminates the phone communication (step #14: Yes), the processing will be ended.

### 2. Second Embodiment

Next, a second embodiment of the handsfree phone device 1 will be explained. In the foregoing first embodiment, it was explained that the voice signal transmitting section 32 transmits a voice signal based on a received call signal to the relay module 20 via the second signal line 50. The second embodiment differs from the first embodiment in that the voice signal transmitting section 32 transmits a voice signal based on a received call signal to the relay module 20 via the first signal line 40. The rest of the configuration is identical to the first embodiment. Thus, in the following discussion, focus will be placed on the differences therebetween.

In this embodiment too, the relay module 20 and the informing terminal 30 are connected to each other via the first signal line 40 as a differential signal line of the universal serial bus and the second signal line 50 as an ID signal line of the universal serial bus, and the first data signal and the second data signal are transmitted/received therebetween via the first signal line 40 and the second signal line 50. That is, the first data signal including the received call signal transmitted from the phone terminal 10 to the relay module 20 is transmitted to the informing terminal 30 via the first signal line 40. Further, the second data signal different from the first data signal is transmitted/received between the relay module 20 and the informing module 30 via the second signal line 50.

In the instant embodiment, the voice signal transmitting section 32 transmits a voice signal based on the received call signal transmitted to the informing terminal 30 via the first signal line 40 to the relay module 20 in the form of a differential signal via the first signal line 40 (differential signal line). In this embodiment, the informing terminal 30 outputs the received call signal included in the first data signal transmitted to this informing terminal 30 from the relay module 20 via the first signal line 40, from the speaker 31. Simultaneously the voice signal converted through a predetermined processing from the speaker driving signal is converted into the first data signal. Here, the voice signal is an analog signal having a waveform which is oscillated in accordance with the kind, magnitude, high/low pitch of the voice. The first data signal is a digital signal comprised of a differential signal. The voice signal transmitting section 32 generates the differential signal and transmits this to the relay module 20 via the first signal line 40.

With the above-described configuration, an analog signal such as a voice signal can be converted into a high-quality digital signal with effective prevention of distortion or signal deterioration in the informing terminal 30. Therefore, it is possible to eliminate echo generation entirely with effective prevention of distortion or signal deterioration.

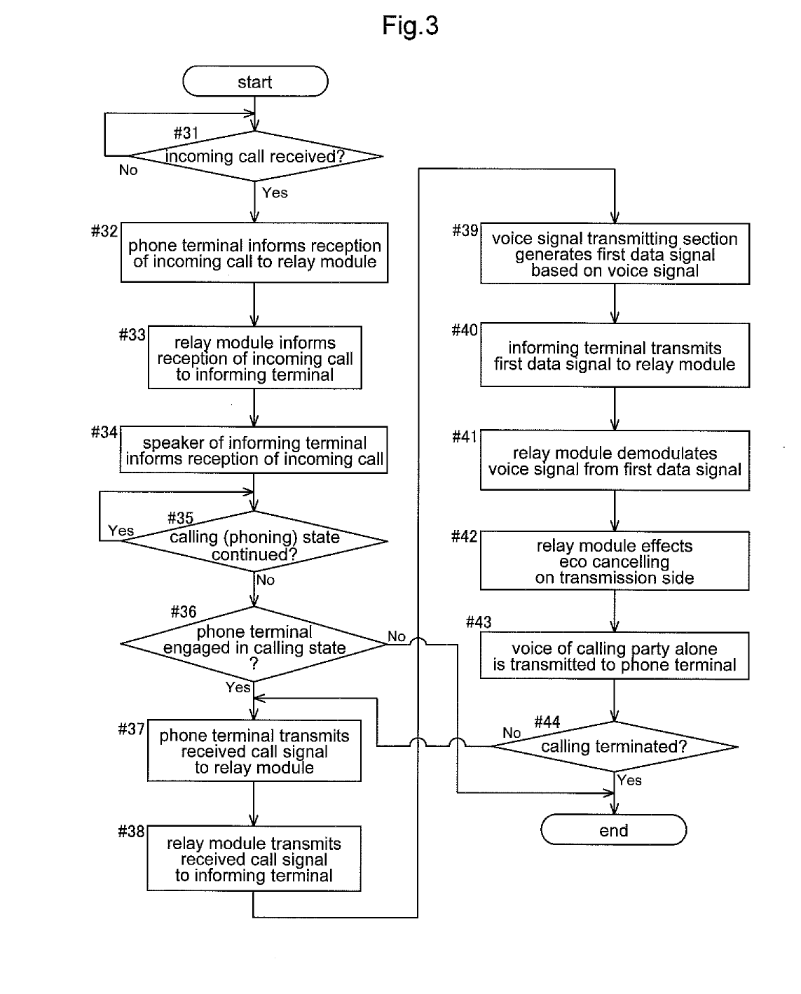

Next, with reference to the flowchart shown in FIG. 3, there will be explained a processing effected by the handsfree phone device 1 relating to the second embodiment. In the following discussion too, like the explanation of the handsfree phone device 1 relating to the first embodiment, there will be explained an example wherein the phone terminal 10 and the relay module 20 effect wireless communication whereas the relay module 20 and the informing terminal 30 effect wired communication, and also reception of an incoming call by the phone terminal 10 is informed via the relay module 20 to the informing terminal 30 and this is then informed by way of a voice via the speaker 31 of the informing terminal 30.

When the phone terminal 10 receives an incoming phone call (step #31: Yes), the phone terminal 10 informs this reception of a phone call to the relay module 20 (step #32). This informing is carried out between the wireless communication section 14 of the phone terminal 10 and the wireless relay section 21 of the relay module 20.

Upon reception of the informing from the phone terminal 10, the relay module 20 informs this reception to the informing terminal 30 (step #33). This informing is carried out by transmission of the differential signal on the first signal line 40 between the wired relay section 22 of the relay module 20 and the wired communication section 33 of the informing terminal 30. Then, the informing terminal 30 informs this reception from the speaker 31 of this informing terminal 30 (step #34). This informing will be continued until termination of the call reception state of the phone terminal 10 (step #35: Yes).

If the cause of the above termination of informing is entry of the phone terminal 10 to a calling (phoning) state (step #36: Yes), when the phone terminal 10 receives a received call signal from another phone terminal 10 of the other (i.e. calling) party, the phone terminal 10 will transmit the received call signal to the relay module 20 (step #37). Then, the relay module 20 transmits this received call signal to the informing terminal 30 via the first signal line 40 (step #38).

Upon receipt of the received call signal, the informing terminal 30 outputs a voice relating to the received call signal from the speaker 31. Simultaneously, the voice signal transmitting section 32 generates a voice signal based on speaker driving signal which is mixture of the received call signal and the signal of the informing terminal 30 (when a sound other than the received call signal is being outputted from the speaker 31) and then generates a first data signal comprising a differential signal based on this voice signal (step #39).

The first data signal produced by the voice signal transmitting section 32 is transmitted to the relay module 20 via the first signal line 40 (step #40). Upon receipt of the first data signal by the relay module 20 from the informing terminal 30, the demodulation section 24 demodulates the first data signal into the voice signal (step #41). The voice signal demodulated by the demodulation section 24 is used for echo cancelling on the transmission side by the relay module 20 (step #42).

The sound outputted from the speaker 31 of the informing terminal 30 is subjected to cancelling by the echo cancelling section 25 and only the voice sound of the calling party is transmitted to the phone terminal 10 (step #43). This processing will be continued until the phone terminal 10 terminates the phone communication (step #44: No). If it is determined at step #36 that the cause of the above termination of informing is not entry of the phone terminal 10 to a calling (phoning) state (step #36: No) or if the phone terminal 10 terminates the phone communication (step #44: Yes), the processing will be ended.

Incidentally, as described above, the informing terminal 30 relating to the present embodiment is configured such that the terminal 30 receives a voice signal based on a received call signal in the form of a digital signal via the first signal line 40, mixes this digital signal with a signal relating to broadcasting of TV, radio, or the like through a digital signal processing and then effects a DA (digital-to-analog) conversion thereon and outputs the result from the speaker 31, and further, the terminal effects a processing for converting this D/A converted analog signal into a digital signal again and transmits this digital signal to the relay module 20 via the first signal line 40. Alternatively, the informing terminal 30 can be configured such that the terminal 30 mixes the signal prior to D/A conversion, i.e. the digital signal received via the first signal line 40 with a signal relating to broadcasting of TV, radio, or the like through a digital signal processing and effects D/A conversion thereon, and then outputs the result from the speaker 31 and also transmits the digital signal obtained by the mixing prior to D/A conversion to the relay module 20 via the first signal line 40.

### 3. Other Embodiments

In the foregoing embodiment, it was explained that the informing terminal 30 informs incoming call reception by the phone terminal 10 by way of a voice. Instead, it is possible to configure the informing terminal 30 such that this terminal 30 effects visual informing of the call reception by the phone terminal 10 by way of illumination or flashing of a lamp or the like.

In the foregoing embodiment, it was explained that the phone terminal 10 and the relay module 20 effect wireless communication. Instead, they can effect wired communication.

In the foregoing embodiment, it was explained that the voice signal transmitting section 23 effects frequency modulation of a voice signal before its transmission. Instead, it is also possible to utilize amplitude modulation. In this case, it becomes possible to eliminate delay in signal transmission. Needless to say, modulation of the voice signal can be effected by any other method.

In the foregoing embodiment, it was explained that the first signal line 40 and the second signal line 50 are formed with using cables of a universal serial bus. Instead, it is also possible to form them with using cables of something other than a universal serial bus.

In the foregoing embodiment, it was explained that the informing terminal 30 comprises a car navigation system. Instead, the informing terminal 30 can comprise a speaker unit constituting the handsfree phone device 1. Further alternatively, the invention may be applied to a video conference system or a phone system using a personal computer, etc.

In the foregoing embodiment, it was explained that to the echo cancelling section 25, a sound other a received call signal outputted from the speaker 31 is added to the second data signal and then transmitted from the voice signal transmitting section 32.

Alternatively, it is also possible to configure such that no sound other than a received call signal outputted from the speaker 31 is transmitted to the echo cancelling section 25.

This disclosure is applicable to a handsfree phone device assisting a user's phone communication using a phone terminal.

1. A handsfree phone device configured to output a call by a user using a phone terminal from a speaker included in an informing terminal, the handsfree phone device comprising:
a relay module configured to communicate with the phone terminal and also to effect wired communication with the informing terminal, thus relaying communication between the phone terminal and the informing terminal; and
a first signal line and a second signal line interconnecting the relay module and the informing terminal;
wherein the handsfree phone device further comprises:
a wired relay section included in the relay module and configured to transmit a received call signal transmitted from the phone terminal to the relay module to the informing terminal via the first signal line;
a voice signal transmitting section included in the informing terminal and configured to transmit a voice signal based on the received call signal to the relay module via one of the first signal line and the second signal line; and
an echo canceling section included in the relay module and configured to reduce an echo generated when the received call signal outputted from the speaker is inputted to a microphone included in the relay module, with use of the voice signal.

2. The handsfree phone device according to claim 1, wherein:
the first signal line and the second signal line respectively comprise a differential signal line and an ID signal line of a universal serial bus; and
the voice signal transmitting section is configured to transmit the voice signal to the relay module, with superposing this voice signal on an ID signal transmitted by the ID signal line.

3. The handsfree phone device according to claim 1, wherein:
the first signal line and the second signal line respectively comprise a differential signal line and an ID signal line of a universal serial bus; and
the voice signal transmitting section is configured to transmit the voice signal to the relay module, by way of a differential signal via the differential signal line.

4. The handsfree phone device according to claim 2, wherein the voice signal transmitting section is configured to transmit a voice signal other than the received call signal outputted from the speaker to the relay module via one of the first signal line and the second signal line for transmitting the voice signal based on the received call signal.

5. The handsfree phone device according to claim 3, wherein the voice signal transmitting section is configured to transmit a voice signal other than the received call signal outputted from the speaker to the relay module via one of the first signal line and the second signal line for transmitting the voice signal based on the received call signal.

6. The handsfree phone device according to claim 1, wherein the voice signal transmitting section is configured to transmit the voice signal with frequency modulation thereof.

7. The handsfree phone device according to claim 2, wherein the voice signal transmitting section is configured to transmit the voice signal with frequency modulation thereof.

8. The handsfree phone device according to claim 3, wherein the voice signal transmitting section is configured to transmit the voice signal with frequency modulation thereof.

9. The handsfree phone device according to claim 4, wherein the voice signal transmitting section is configured to transmit the voice signal with frequency modulation thereof.

10. The handsfree phone device according to claim 5, wherein the voice signal transmitting section is configured to transmit the voice signal with frequency modulation thereof.
